(19) United States
(12) Patent Application Publication
(10) Pub. No.: US 2021/0390622 A1
(43) Pub. Date: Dec. 16, 2021

(54) MANAGEMENT APPARATUS AND MANAGEMENT METHOD

(71) Applicant: Wook LIM, Ulsan (KR)

(72) Inventor: Wook LIM, Ulsan (KR)

(21) Appl. No.: 17/260,873

(22) PCT Filed: Sep. 10, 2020
(86) PCT No.: PCT/KR2020/012232

§ 371 Date: Jan. 15, 2021

(30) Foreign Application Priority Data
Sep. 27, 2019 (KR) 10-2019-0119368

(51) Int. Cl. G06Q 40/06; G06Q 50/00; G06Q 30/02

(52) U.S. Cl. CPC G06Q 40/06; G06Q 30/0273; G06Q 50/01

(57) ABSTRACT

Provided is a management apparatus including: a registration unit registering an investment product of a supplier; an investment unit providing information on the investment product and an investment menu for the investment product; a deletion unit deleting the investment product according to a participation progress state of investors for the investment product; a selection unit selecting a recipient of the investment product among the investors who invest an investment amount in the investment product; and a settlement unit refunding the investment amount to all the investors for the investment product after a business between the supplier and the recipient for the investment product is completed, wherein the settlement unit pays a performance-based bonus to the supplier depending on a scale of a total investment amount for the investment product.

### TECHNICAL FIELD

The present disclosure relates to an apparatus and a method of managing social commerce funding.

### BACKGROUND ART

Conventional peer-to-peer (P2P) finance systems are limited because they are unable to be affected by individual characteristics and individualities of users having various purposes. Therefore, new funding, transaction methods, and the like need to be considered to remove limitations on conventional commercial trading methods in investment products in limited categories and social commerce Internet shopping malls.

Korean Patent Application Publication No. 10-2014-0092500 discloses a system that issues a coupon to help to improve the optimum marketing effect.

### DISCLOSURE

### Technical Problem

The present disclosure is directed to providing an apparatus and a method of managing social commerce funding.

It is to be understood that technical problems to be solved by the present disclosure are not limited to the aforementioned technical problems and other technical problems which are not mentioned will be apparent from the following description to a person with an ordinary skill in the art to which the present disclosure pertains.

### Technical Solution

According to the present disclosure, there is provided a management method including: accessing, by users, a management server having a social commerce funding platform through the Internet and an offline branch and joining as members when the users are non-members; distinguishing, authenticating, and identifying the member's login, an operator's login, and a supplier's login to the management server; registering, by the member, the operator, and the supplier, items of investment products and generating services through an analysis production system in an investment product registration process; registering, by an advertiser, an advertisement according to an advertisement registration process; selecting, by the member and the non-member, the item of the investment product desired and participating in investment as investors; watching the advertisement in a process of participating in the investment; checking, by the advertiser, performance of the advertisement through an advertisement status system and paying an advertising cost; checking, by a follow-up check system in an investment participation and determination process after participation in the investment, whether the items satisfy a condition and determining whether to delete the items; selecting, after it is determined that the item satisfies the condition, the investor to receive the item through an investor selection system; imposing, a product purchase fee and a supplier fee to the supplier with respect to an investment product uploaded for a direct sale among the items determined to satisfy the condition; presenting the selected investor with the item of the investment product; refunding an investment amount and a fee to all the investors; and paying, depending on an investment scale and performance of participation for the investment product designed and uploaded by a general member, a host design performance-based bonus to the general member.

According to the present disclosure, there is provided is a management apparatus including: a registration unit registering an investment product of a supplier; an investment unit providing information on the investment product and an investment menu for the investment product; a deletion unit deleting the investment product according to a participation progress state of investors for the investment product; a selection unit selecting a recipient of the investment product among the investors who invest an investment amount in the investment product; and a settlement unit refunding the investment amount to all the investors for the investment product after a business between the supplier and the recipient for the investment product is completed, wherein the settlement unit pays a performance-based bonus to the supplier depending on a scale of a total investment amount for the investment product.

### Advantageous Effects

The management apparatus and the management method of the present disclosure can fuse characteristics of factors of P2P finance and social commerce industries through social power. Through fusion of P2P finance and social commerce, high profits are provided to investors and low interest rates are provided to suppliers receiving investment.

### DESCRIPTION OF DRAWINGS

FIG. 1 is a flowchart showing a management method according to an embodiment of the present disclosure.

FIG. 2 is a schematic diagram showing a management apparatus according to an embodiment of the present disclosure.

FIG. 3 is a schematic diagram showing a registration unit.

FIG. 4 is a schematic diagram showing a deletion unit.

FIG. 5 is a schematic diagram showing a selection unit.

FIG. 6 is an overall flowchart showing social commerce funding of the present disclosure.

FIG. is a flowchart showing a procedure for a supplier to register an investment product.

FIG. 8 is a flowchart showing a procedure for imposing a fee to a supplier who has the purpose of a direct sale.

FIG. 9 is a flowchart showing a procedure for paying a general member a performance-based bonus.

FIG. 10 is a flowchart showing an advertisement registration process.

### BEST MODE

Hereinafter, embodiments of the present disclosure will be described with reference to the accompanying drawings. In describing, sizes or shapes of elements shown in the drawings may be exaggerated for clarity and convenience of description. Further, terms specifically defined considering configurations and operations in the embodiments of the present disclosure may vary according to the intention of the user, the operator, or the custom. The definitions of the terms should be based on the contents throughout this specification.

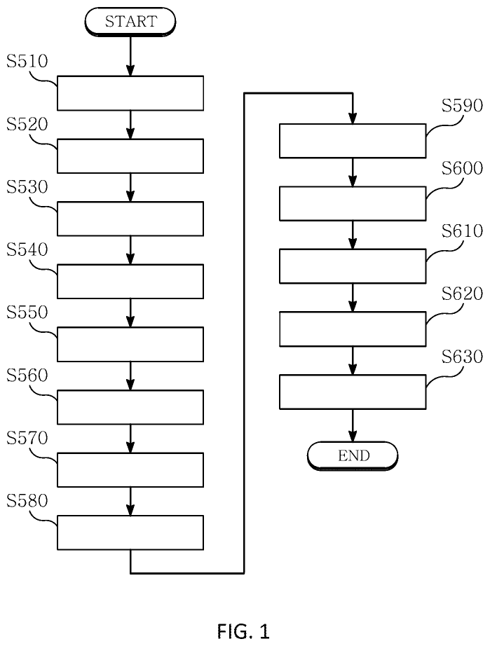

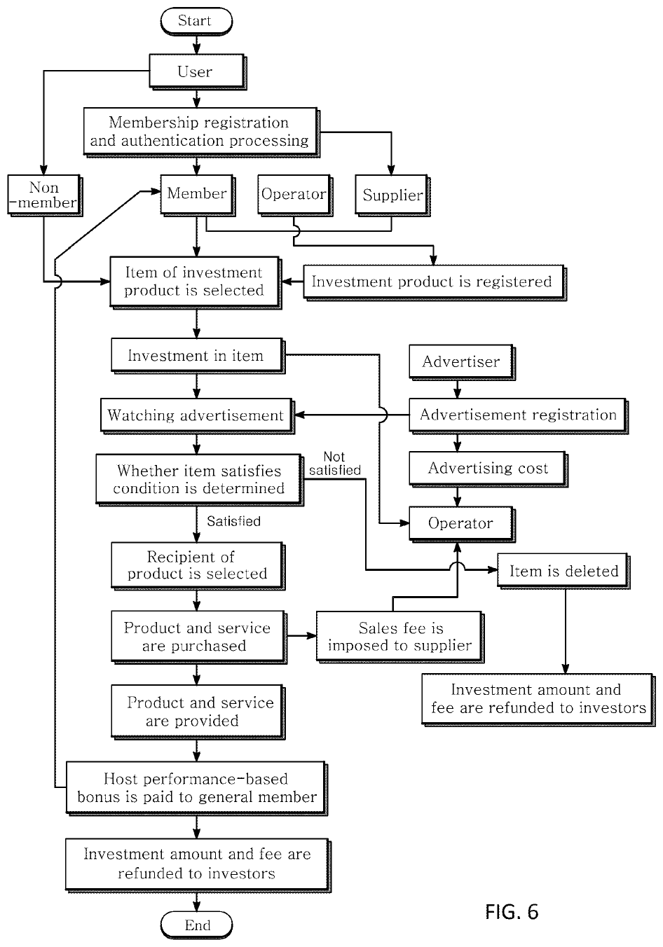

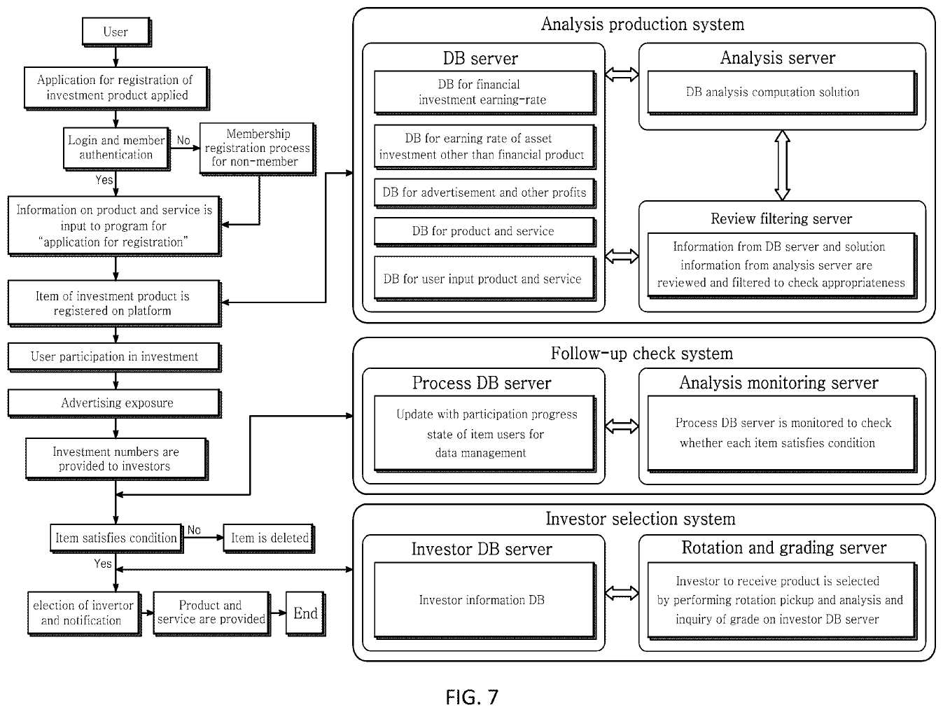

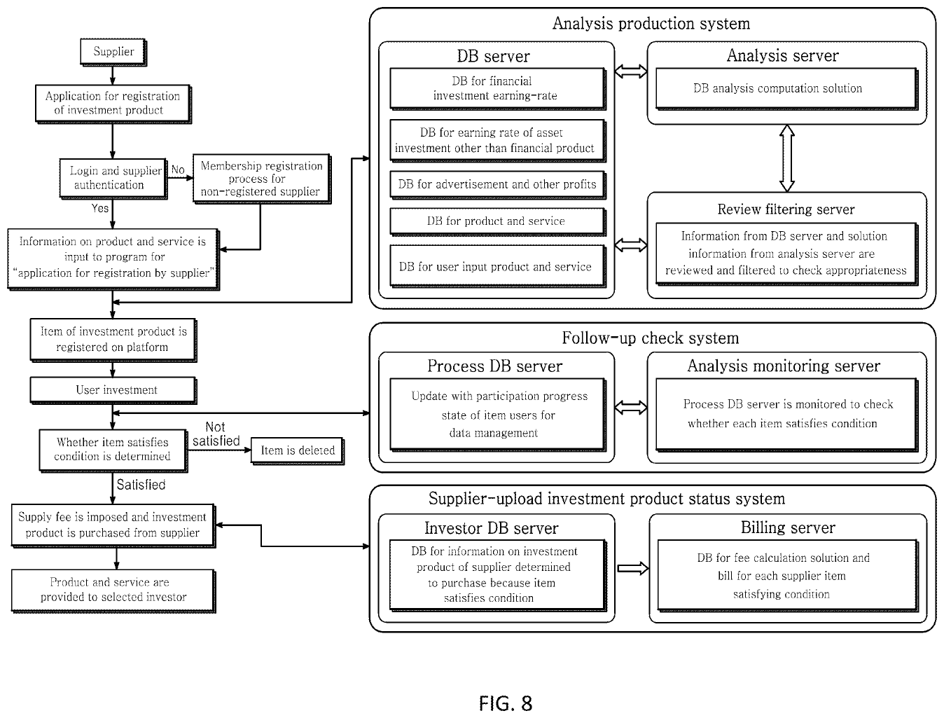

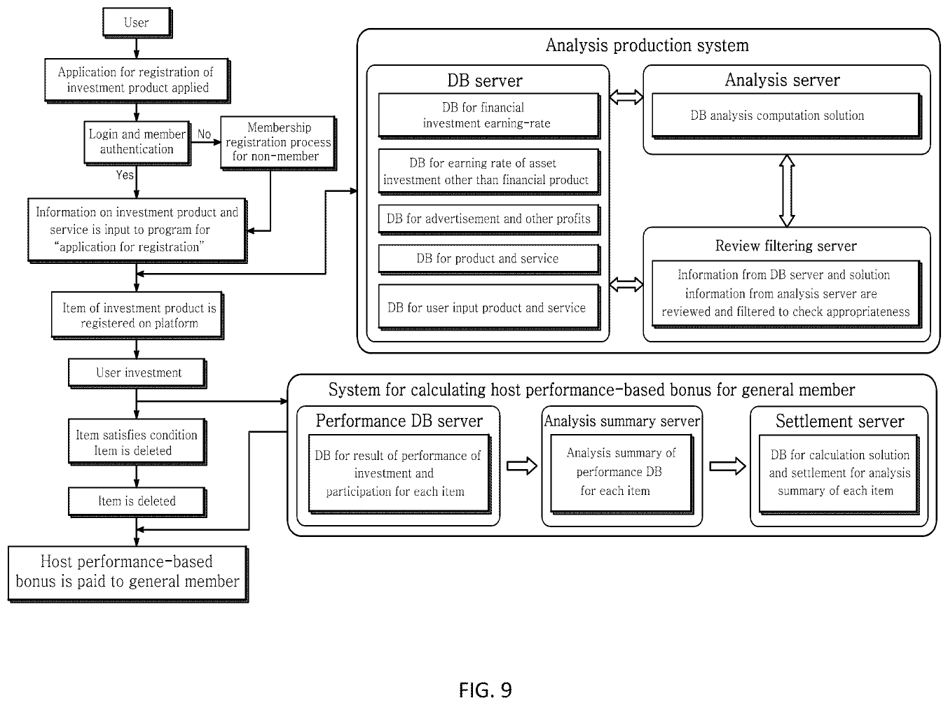

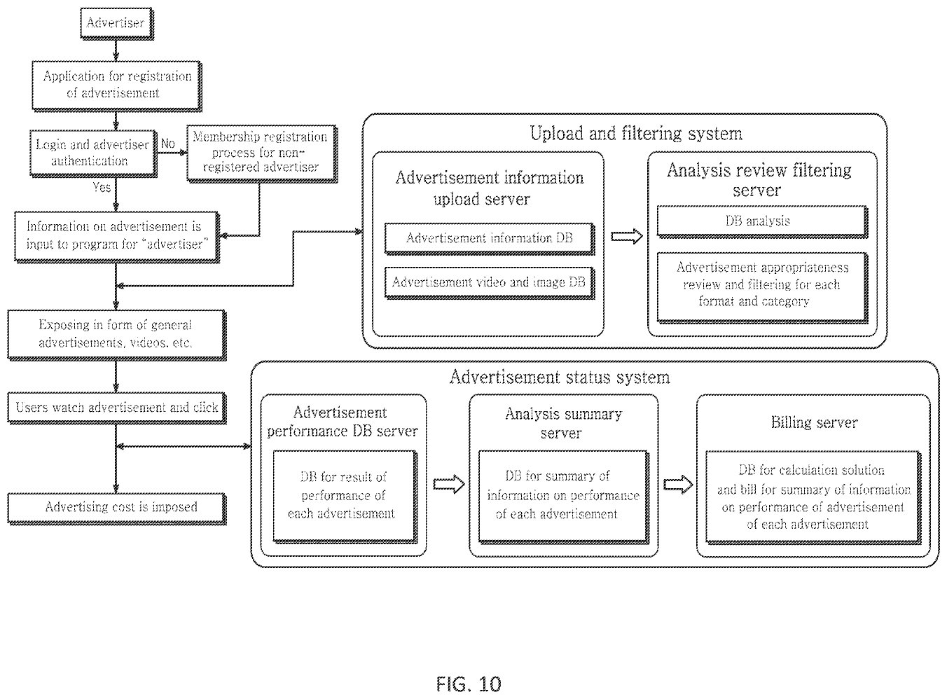

FIG. 1 is a flowchart showing a management method according to an embodiment of the present disclosure. FIG. 6 is an overall flowchart showing social commerce funding of the present disclosure. FIG. 7 is a flowchart showing a procedure for a supplier to register an investment product. FIG. 8 is a flowchart showing a procedure for imposing a fee to a supplier who has the purpose of a direct sale. FIG. 9 is a flowchart showing a procedure for paying a general member a performance-based bonus. FIG. 10 is a flowchart showing an advertisement registration process.

The management method shown in the drawings may be performed by a management apparatus which will be described below. The management apparatus may include a server or hardware system that provides a social commerce funding service.

The present disclosure may relate to the fusion of characteristics of a P2P finance service and a social commerce business that have achieved the growth based on a social network in the paradigm of information and communications technology (ICT) convergence in the era of the fourth industrial revolution.

The present disclosure makes investment products of conventional P2P finance into items of social commerce product and service types so that investors are able to directly invest on desired products and services. Through this, various revenue sources using social power may be generated. The present disclosure relates to a business model and a service platform that are a new concept of advanced social commerce funding wherein instead of recipients of investment products, profits earned from various revenue sources pay for the products so that the recipients receive products and services for free.

Specifically, any supplier is able to register a desired product or service as an investment product in the service platform. This is advanced from a P2P finance service platform. The supplier may perform uploading according to a registration process and make an investment product into an item. When the item satisfies a period, regulations, and requirements specified by an analysis production system of the service platform, a product or service is supplied for free to one or multiple investors who are selected by various methods, such as drawing lots, grading, etc., according to an investor selection system, or to all participating investors.

Starting from a step of generating a service, social commerce funding recruits users through online services using social-based media and the Internet infrastructure, such as social networks, mobile messengers, search engines, etc., and various types of offline branches, such as shopping centers, convenience stores, etc. The users use the social commerce funding according to a management method of FIG. 1. Herein, the users may include a supplier who supplies or provides an investment product, an investor who provides an investment amount for the investment product, and a recipient who receives the investment product. The users may pay an investment fee set for each item for the purpose of participation.

The analysis production system and a follow-up check system (follow up & check) may update a participation progress state of the users for investment. During a preset period, it is checked whether an item satisfies a condition and decision is made. After the period elapses, the investment principal and the fee are automatically returned. Among items uploaded for direct sales, when the item satisfies a condition, a sales fee is imposed to the supplier. A host performance-based bonus may be paid depending on performance of investment and participation activity for an investment product that is designed and uploaded by a general member. Through an advertisement registration process and an advertisement status system, the advertiser who wants to register an advertisement may register the advertisement, check performance of the registered advertisement, and pay an advertising cost.

The social commerce funding described above may be implemented by the management method shown in FIG. 1.

Users may access a management server having a social commerce funding platform through the Internet and an offline branch, and when the users are not a member, the users join as a member at step S510.

A member's login, an operator's login, and a supplier's login to the management server may be distinguished, authenticated and identified at step S520.

The member, the operator, and the supplier may register items of investment products and generate services through the analysis production system in an investment product registration process at step S530.

The advertiser may register an advertisement according to the advertisement registration process at step S540.

A member and a non-member may select an item of a desired investment product and participate in the investment at step S550.

The member and the non-member who participate in the investment, that is, investors, may watch an advertisement in a process of participating in the investment at step S560.

The advertiser may check the performance of the advertisement through the advertisement status system and pay the advertising cost at step S570. In the present disclosure, an advertisement is a very important factor. The present disclosure has the characteristics of social commerce wherein a large number of users invest. Using this, the effect of an advertisement may be maximized. Numerous advertisers participate to take advantage of powerful effect on advertisements, contributing to improvement in practicality of paying by proxy for an investment product. In other words, in a social commerce funding environment of the present disclosure where the investment amount is returned to all investors later and investment products are provided to at least some of the investors for free, the advertising cost functions as a source enabling the investment products to be provided for free.

After participation in the investment, the follow-up check system in an investment participation and determination process may check whether the items satisfy a condition and may determine whether to delete the items at step S580. In an environment having the characteristics of social commerce, that is, an environment where anyone who joins as a member is able to register an investment product or service, excessively over-registered investment products need to be quickly deleted. According to the follow-up check system, when the number of investors who invest in a particular investment product, an investment amount, or the like does not satisfy a set condition, the investment product is deleted by the management apparatus. The investment amount invested in the deleted investment product may be returned to all the investors.

After it is determined that the item satisfies the condition, an investor to receive the item may be selected through the investor selection system at step S590. A state where the set condition, such as the number of investors, an investment amount, or the like, is satisfied may be expressed as that the item is “satisfied”. The item (an investment product and an investment service) determined to satisfy the condition may be provided to an investor for free. Since the items are provided free of charge, it may be difficult to provide the items to all the investors. In this case, an operation of selecting a recipient of the item is required, and this step may include the operation.

Among items determined to satisfy the condition, with respect to the investment product uploaded for a direct sale, a product purchase fee and a supplier fee may be imposed to the supplier systematically at step S600. In order to make the social commerce funding active, a special investment product different from a general investment product for the purpose of the investment amount may be allowed to be registered. For example, a particular supplier may register a used product for sale. In this case, the used product is an already complete product and may thus be classified as a special investment product for simple sale not requiring an investment amount. The management apparatus of the present disclosure allows registration of the special investment product freely, but imposes a product purchase fee to a recipient (herein, having the nature of a buyer) or a sales fee to a supplier (herein, having the nature of a seller). The fee may be used to increase the number of general investment products provided free of charge.

A selected investor may be presented with the item of the investment product at step S610.

The investment amount and the fee may be refunded to all the investment participants at step S620.

Depending on the investment scale and the performance of participation for the investment product that is designed and uploaded by a general member, a host design performance-based bonus may be paid to the general member. A large number of investors for a particular investment product may mean that there are many users who watch an advertisement. This means an increase in an acquirable advertising cost. The larger the amount, the greater the number of investors who are allowed to receive investment products for free. In addition, by paying the performance-based bonus to the general member who registers an investment product, a high-quality investment product is induced to be registered.

When the investment amount for a particular investment product is large, interest is likely to be earned due to deposit of the large investment amount during the period until the supplier produces the item of the investment product by using the investment amount. Herein, the interest may be used like the advertising cost.

The analysis production system may include a first database 111, an analysis part 113, and a review filtering part 115.

The first database 111 may store the following information and provide the same to the users: information on a current earning rate of investment that an operator may provide, information on an earning rate of asset investment other than a financial product, information on an earning rate that an advertisement and other operators may provide, information that may reflect a current market price of a product and a service, and information on a product or service that a user uploads. The operator may refer to a user who operates the management apparatus.

The analysis part 113 may manage information on use of the social commerce funding service and may compute requirements and guidelines required for executing the social commerce funding service by analyzing, on the basis of the information stored in the first database 111, a product and a service that are desired by a user to be uploaded.

The review filtering part 115 may review the information stored in the first database 111 or the information computed by the analysis part 113 and may perform filtering thereon, thereby checking appropriateness.

The service uploaded through the analysis production system may be made into an item and the item may be displayed as being in a participatable state on a user terminal.

Investors may be given investment numbers distinguishable from each other.

The investment numbers given to the investors may be transferred to the follow-up check system.

The follow-up check system may include a second database 151 and an analysis monitoring part 153.

The second database 151 may be updated with the participation progress state of the users. The participation progress state may include at least one among the number of participants, the collected amount, and a period.

The analysis monitoring part 153 may check whether the requirements and the guidelines set for the item are satisfied by using the participation progress state, and may determine whether to delete the item.

The investor selection system may include a third database 171 and a rotation and grading part 173.

The third database 171 may store information on the investors. The information on the investors may be used in returning of the investment amount. The information on the investors may be used as recipients' contact addresses, and the like, when an item of the investment product is provided.

The rotation and grading part 173 may select an investor to receive an item, through rotation pickup and analysis and inquiry of a grade by using the information stored in the third database 171. The investor selected by the rotation and grading part 173 may be a recipient of the item.

A notification message is given to the particular investor selected by the rotation and grading part 173, and a product may be provided without additional cost.

When it is determined that the investment product satisfies a condition or that the item is to be deleted, the investment amount and the fee for the investment amount are automatically returned to all the investors.

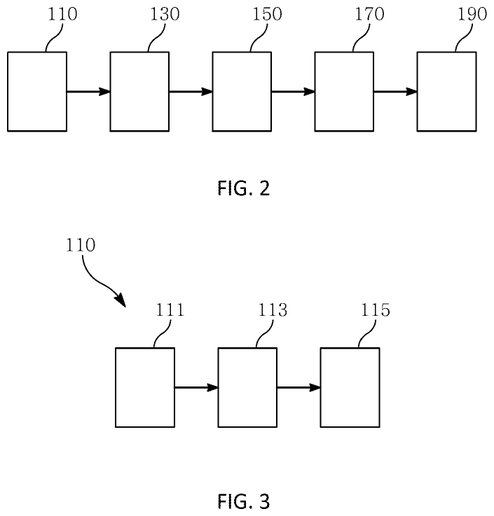

FIG. 2 is a schematic diagram showing a management apparatus of the present disclosure.

The management apparatus shown in FIG. 2 may include a registration unit 110, an investment unit 130, a deletion unit 150, a selection unit 170, and a settlement unit 190.

The registration unit 110 may register an investment product of the supplier.

The investment unit 130 may provide information on the investment product and an investment menu for the investment product.

The deletion unit 150 may delete the investment product according to the participation progress state of investors for the investment product.

The selection unit 170 may select, among the investors who invest an investment amount in the investment product, a recipient of the investment product.

The settlement unit 190 may refund the investment amount to all the investors for the investment product after a business between the supplier and the recipient for the investment product is completed. The settlement unit 190 may pay a performance-based bonus to the supplier depending on the scale of the total investment amount for the investment product. For example, when the total investment amount meets a set value, the settlement unit 190 pays the performance-based bonus to the supplier. The performance-based bonus is generated when a number of investors provide a large investment amount, so that the supplier may be induced to plan a high-quality investment product so as to attract a large investment amount.

FIG. 3 is a schematic diagram showing the registration unit 110.

The registration unit 110 may include the first database 111, the analysis part 113, and the review filtering part 115.

The first database 111 may store the following information and provide the same to suppliers or investors: information on a current earning rate of investment that an operator may provide, information on an earning rate of asset investment other than a financial product, information on an earning rate that an advertisement and other operators may provide, information that may reflect a current market price of a product and a service, and information on a product or service that a supplier uploads.

The analysis part 113 may compute requirements and guidelines required for executing the social commerce funding service by analyzing an investment product that is desired by a supplier to be uploaded, on the basis of the information stored in the first database 111.

The review filtering part 115 may review the information stored in the first database 111 or the information computed by the analysis part 113 and may perform filtering thereon, thereby checking appropriateness.

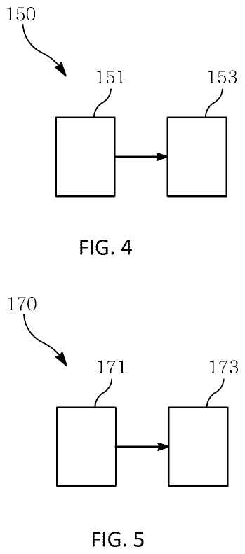

FIG. 4 is a schematic diagram showing the deletion unit 150.

The deletion unit 150 may include the second database 151 and the analysis monitoring part 153.

The second database 151 may be updated with the participation progress state of the investors.

The analysis monitoring part 153 may check whether the requirements and the guidelines set for the investment product are satisfied by using the participation progress state, and may determine whether to delete the investment product.

FIG. 5 is a schematic diagram showing the selection unit 170.

The selection unit 170 may include the third database 171 and the rotation and grading part 173.

The third database 171 may store information on the investors.

The rotation and grading part 173 may perform rotation pickup and analysis and inquiry of a grade by using the information stored in the third database 171 and may select an investor to receive an item.

The embodiments of the present disclosure have been described for illustrative purpose, and those skilled in the art to which the present disclosure pertains will easily understand that the present disclosure may be modified in various ways and that other equivalent embodiments are possible. Accordingly, the true range of protection of the present disclosure should be determined by the following claims.

### DESCRIPTION OF THE REFERENCE NUMERALS IN THE DRAWINGS

110 Registration unit
111 First database
113 Analysis part
115 Review filtering part
130 Investment unit
150 Deletion unit
151 Second database
153 Analysis monitoring part
170 Selection unit
171 Third database
173 Rotation and grading part
190 Settlement unit

### INDUSTRIAL APPLICABILITY

The management apparatus and the management method according to the present disclosure can fuse characteristics of factors of P2P finance and social commerce industries through social power, and can provide, through fusion of P2P finance and social commerce, high profits to investors and low interest rates to suppliers receiving investment.

1. A management method of operating a social commerce funding service, the method comprising:
accessing, by users, a management server having a social commerce funding platform through the Internet and an offline branch and joining as members when the users are non-members;
distinguishing, authenticating, and identifying the member's login, an operator's login, and a supplier's login to the management server;
registering, by the member, the operator, and the supplier, items of investment products and generating services through an analysis production system in an investment product registration process;
registering, by an advertiser, an advertisement according to an advertisement registration process;
selecting, by the member and the non-member, the item of the investment product desired, and participating in investment as investors;
watching the advertisement in a process of participating in the investment;
checking, by the advertiser, performance of the advertisement through an advertisement status system and paying an advertising cost;
checking, by a follow-up check system in an investment participation and determination process after participation in the investment, whether the items satisfy a condition and determining whether to delete the items;
selecting, after it is determined that the item satisfies the condition, the investor to receive the item through an investor selection system;
imposing, a product purchase fee and a supplier fee to the supplier with respect to an investment product uploaded for a direct sale among the items determined to satisfy the condition;
presenting the selected investor with the item of the investment product;
refunding an investment amount and a fee to all the investors; and
paying, depending on an investment scale and performance of participation for the investment product designed and uploaded by a general member, a host design performance-based bonus to the general member.

2. The method of claim 1, wherein the analysis production system comprises a first database, an analysis part, and a review filtering part,
the first database stores information on a current earning rate of investment that the operator provides, information on an earning rate of asset investment other than a financial product, information on an earning rate that the advertisement and other operators provide, information reflecting a current market price of the products and the services, and information on the products or the services that the users upload, and provides the stored information to the supplier or the investors,
the analysis part manages information on use of the social commerce funding service and computes requirements and guidelines required for executing the social commerce funding service by analyzing, on the basis of the information stored in the first database, the product and the service that are desired by the users to be uploaded,
the review filtering part reviews the information stored in the first database or the information computed by the analysis part and performs filtering thereon, thereby checking appropriateness,
the services uploaded through the analysis production system are made into the items and the items are displayed as being in a participatable state on a user terminal,
the investors are given investment numbers distinguishable from each other,
the investment numbers given to the investors are transferred to the follow-up check system,
the follow-up check system comprises a second database and an analysis monitoring part,
the second database is updated with a participation progress state of the users,
the analysis monitoring part checks whether requirements and guidelines set for the item are satisfied by using the participation progress state, and determines whether to delete the item,
the investor selection system comprises a third database and a rotation and grading part,
the third database stores information on the investors,
the rotation and grading part performs rotation pickup and analysis and inquiry of a grade by using the information stored in the third database and selects the investor to receive the item,
a notification message is given to the particular investor selected by the rotation and grading part and the product is provided without additional cost, and
when it is determined that the investment product satisfies the condition or that the item is to be deleted, the investment amount and the fee for the investment amount are automatically returned to all the investors.

3. A management apparatus, comprising:
a registration unit registering an investment product of a supplier;
an investment unit providing information on the investment product and an investment menu for the investment product;
a deletion unit deleting the investment product according to a participation progress state of investors for the investment product;
a selection unit selecting a recipient of the investment product among the investors who invest an investment amount in the investment product; and
a settlement unit refunding the investment amount to all the investors for the investment product after a business between the supplier and the recipient for the investment product is completed,
wherein the settlement unit pays a performance-based bonus to the supplier depending on a scale of a total investment amount for the investment product.

4. The management apparatus of claim 3, wherein the registration unit comprises a first database, an analysis part, and a review filtering part,
the first database stores information on a current earning rate of investment that an operator provides, information on an earning rate of asset investment other than a financial product, information on an earning rate that an advertisement and other operators provide, information reflecting a current market price of the product and a service, and information on the product or the service that the supplier uploads, and provides the stored information to the supplier or the investors,
the analysis part computes requirements and guidelines required for executing a social commerce funding service by analyzing the investment product that is desired by the supplier to be uploaded, on the basis of the information stored in the first database, and
the review filtering part reviews the information stored in the first database or the information computed by the analysis part and performs filtering thereon, thereby checking appropriateness.

5. The management apparatus of claim 3, wherein the deletion unit comprises a second database and an analysis monitoring part,
the second database is updated with the participation progress state of the investors, and
the analysis monitoring part checks whether requirements and guidelines set for the investment product are satisfied by using the participation progress state, and determines whether to delete the investment product.

6. The management apparatus of claim 3, wherein the selection unit comprises a third database and a rotation and grading part,
the third database stores information on the investors, and
the rotation and grading part performs rotation pickup and analysis and inquiry of a grade by using the information stored in the third database and selects the investor to receive an item of the investment product.
